(19) United States
(12) Patent Application Publication
(10) Pub. No.: US 2009/0150951 A1
(43) Pub. Date: Jun. 11, 2009

(54) ENHANCED CAPTIONING DATA FOR USE WITH MULTIMEDIA CONTENT

(75) Inventors: Armstrong Soo, San Ramon, CA (US); Bernard Ku, Austin, TX (US); Zhi Li, Martinez, CA (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/951,996

(22) Filed: Dec. 6, 2007

(51) Int. Cl. H04N 7/173; H04N 7/08

(52) U.S. Cl. 725/110; 725/137

(57) ABSTRACT

An enhanced captioning module suitable for use in a multimedia reception and display system includes an interface to receive a set of multimedia elements representative of at least a portion of multimedia content, a detection unit to determine a type of at least a portion of the multimedia elements and to assert a trigger signal when the multimedia element has a selected type, and a hash unit to generate a hash value corresponding to the “triggering” multimedia element. The module may further include a message unit to generate an enhanced captioning message that is deliverable to an enhanced captioning database. The enhanced captioning message may include information indicative of the hash value and the enhanced captioning database may include enhanced captioning data corresponding to the multimedia content. The enhanced captioning database may be configured to be indexed by the hash value.

### BACKGROUND

1. Field of the Disclosure

The present disclosure relates to multimedia content including television, movies, and other motion video content and, more specifically, the use of captioning data in conjunction with multimedia content.

2. Description of the Related Art

Closed captioning is widely employed in television and recorded movies such as digital video disks (DVDs) and the like. Typically, however, conventional closed captioning text is available only in a very limited number of languages.

### BRIEF DESCRIPTION OF THE DRAWINGS

FIG. 1 is a block diagram of selected elements of an embodiment of a multimedia content distribution network supporting enhanced captioning;

FIG. 2 is a block diagram showing selected elements of an embodiment of a reception and display system;

FIG. 3 is a block diagram of selected elements of an embodiment of an enhanced captioning module;

FIG. 4 is a flow diagram depicting selected elements of an embodiment of an enhanced captioning method;

FIG. 5 is a flow diagram depicting selected elements of an embodiment of a method for enabling enhanced captioning; and

FIG. 6 illustrates selected elements of an embodiment of an enhanced captioning database.

### DESCRIPTION OF THE EMBODIMENT(S)

In one aspect, an enhanced captioning module suitable for use in a multimedia reception and display system includes an interface to receive a set of multimedia elements representative of at least a portion of multimedia content, a detection unit to determine a type of at least a portion of the multimedia elements and to assert a trigger signal when a multimedia element has a selected type, and a hash unit to generate a hash value corresponding to the “triggering” multimedia element. The module may further include a message unit to generate an enhanced captioning message that is deliverable to an enhanced captioning database. The enhanced captioning message may include information indicative of the hash value and the enhanced captioning database may include enhanced captioning data corresponding to the multimedia content. The enhanced captioning database may be configured to be indexed by the hash value.

The multimedia content may include a set or sequence of frames and the multimedia elements may include encoded representations of the frames. The types of multimedia elements may include an I-type and at least one other type where an I-type multimedia element is encoded without reference to preceding or subsequent multimedia elements, i.e., has no temporal references to other frames. In some embodiments, I-type multimedia elements are triggering multimedia elements. The I-type elements may be encoded in compliance with any of various encoding standards including, for example, MPEG-1, MPEG-2, and/or MPEG-4 standards, and the Windows Media Video (WMV) standards family of, or other suitable standards.

The message unit may generate the enhanced captioning message when a condition is satisfied. The condition may be satisfied when the trigger signal is asserted or when a selected type of frame or element is otherwise detected. Satisfaction of the condition may further require the expiration of a refresh interval, the detection of a channel change, or the detection of another event such as a playback event including, as examples, a pause, resume, reverse, forward, fast forward, or other type of playback event. The message unit may transmit the enhanced captioning message to a remotely located enhanced captioning database via a network to which the enhanced captioning database is connected. The enhanced captioning database may be remotely connected to the enhanced captioning module via a public network such as the Internet, an access network that is private, or a combination of both. The hash value in the enhanced captioning message may be used to index or otherwise query the enhanced captioning database. The enhanced captioning message, when received and processed by the enhanced captioning database, may cause the enhanced captioning database to transmit at least a portion of the enhanced captioning data to an enhanced captioning buffer.

The enhanced captioning buffer may be accessible to a set top box operable to cause a display device to display the enhanced captioning data in conjunction with displaying the multimedia content. The enhanced captioning module may be integrated as an element of the set top box or implemented as a stand alone module in communication with the set top box. The enhanced captioning data may include captioning text that is in a non standard language such as a language other than English, French, or Spanish.

In another aspect, a disclosed method of implementing enhanced captioning for multimedia content includes enabling an enhanced captioning module capable of monitoring a multimedia content stream to generate identity information that is sufficient to identify uniquely a frame of the multimedia content stream at approximately the same time that the identified frame is playing. The method further includes enabling the enhanced captioning module to transmit the identity information to an enhanced captioning database where the identity information causes the enhanced captioning database to transmit enhanced captioning data, applicable to the identified frame, to an enhanced captioning buffer.

The method may still further include enabling a display system, including a set top box having access to the enhanced captioning buffer, to display the enhanced captioning data in conjunction with the multimedia content. The enhanced captioning data may be displayed, for example, as captioning text presented in an “overlay” window that occupies a portion of the display screen and overlies the multimedia video. The enhanced captioning module may identify a frame by applying a hashing algorithm or encryption algorithm, e.g., message digest 5 (MD5), to the bits or binary content of the frame to generate a hash value corresponding to the frame. In some embodiments, the encryption algorithm is applied to the bits of an encoded or otherwise compressed representation of the frame.

The enhanced captioning module may generate and/or transmit a hash value or other frame identifying information to the enhanced captioning database only for select types of frames such as I-type frames. Moreover, the enhanced captioning module may generate and/or transmit a hash value or other frame identifying information for select types of frames only if a second condition is satisfied, for example, when a refresh timer or interval expires. Thus, the enhanced captioning module may be enabled such that the enhanced captioning database is accessed only periodically or from time to time when one or more conditions are satisfied. The enhanced captioning module may be enabled to access the enhanced captioning database following the satisfaction of other secondary conditions such as detecting various playback events or remote control events including, as examples, channel change, play, forward, reverse, and fast forward events. The enhanced captioning data may include captioning text presented in a language other than a language that might be supported by legacy National Television System Committee (NTSC) or other closed captioning implementations, e.g., other than English, French, or Spanish.

In some embodiments, the method further includes enabling third parties to provide enhanced captioning databases in various languages by enabling third parties to generate identity information matching the identity information generated by the enhanced captioning module and to enable the third parties to design their enhanced captioning databases to be accessible by an enhanced captioning module in a standardized way, e.g., through the use of application programming interfaces.

In some embodiments, the enhanced captioning database includes a plurality of key records wherein at least some of the key records include an identity information field and a corresponding enhanced captioning data field. The key records might, for example, correspond to I-frames in a multimedia content sequence. In some embodiments, multiple records of enhanced captioning data are transmitted to the enhanced captioning buffer when the enhanced captioning database is accessed. The multiple records may include a key record containing enhanced captioning data corresponding to an I-frame or other type of key frame and one or more intermediate records that correspond, for example, to frames occurring between successive I-frames.

In some other embodiments, all enhanced captioning database records, both key and intermediate, applicable to the multimedia content are retrieved upon hashing the first detected I-frame. In these embodiments, each record may include a title field or other field containing information that uniquely identifies the corresponding multimedia content, e.g., the movie or television show. Each record may also include a sequence field or frame number field containing, for example, an integer value that uniquely identifies a corresponding frame of the multimedia content. When the first I-frame is encountered, the hash value identifies a particular key record from which the title can be determined. All other chronologically subsequent records for the same title may then be retrieved and stored in the enhanced captioning buffer. The enhanced captioning module may then retrieve enhanced captioning data from the enhanced captioning buffer using the frame numbers. In these embodiments, the enhanced captioning module may periodically or from time to time hash a key frame and access the enhanced captioning database to ensure that the content being played has not changed and that the video and enhanced captioning data are still acceptably synchronous.

In another aspect, a disclosed computer program product, which comprises computer executable instructions, stored on a computer readable medium, for processing enhanced captioning data pertaining to multimedia content, includes instructions to monitor a set of multimedia elements representative of at least a portion of multimedia content being played to a display device, determine a type of at least a portion of the multimedia elements and to identify a multimedia element as a triggering multimedia element when a type of the multimedia element matches a selected type, generate a hash value corresponding to the triggering multimedia element, and generate a message that is deliverable to an enhanced captioning database. The message indicates the hash value and thereby indicates the corresponding multimedia element. The enhanced captioning database includes at least some records containing enhanced captioning data where the records are indexed or otherwise searchable via the hash value.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 102-1 refers to an instance of a widget class, which may be referred to collectively as widgets 102 and any one of which may be referred to generically as a widget 102.

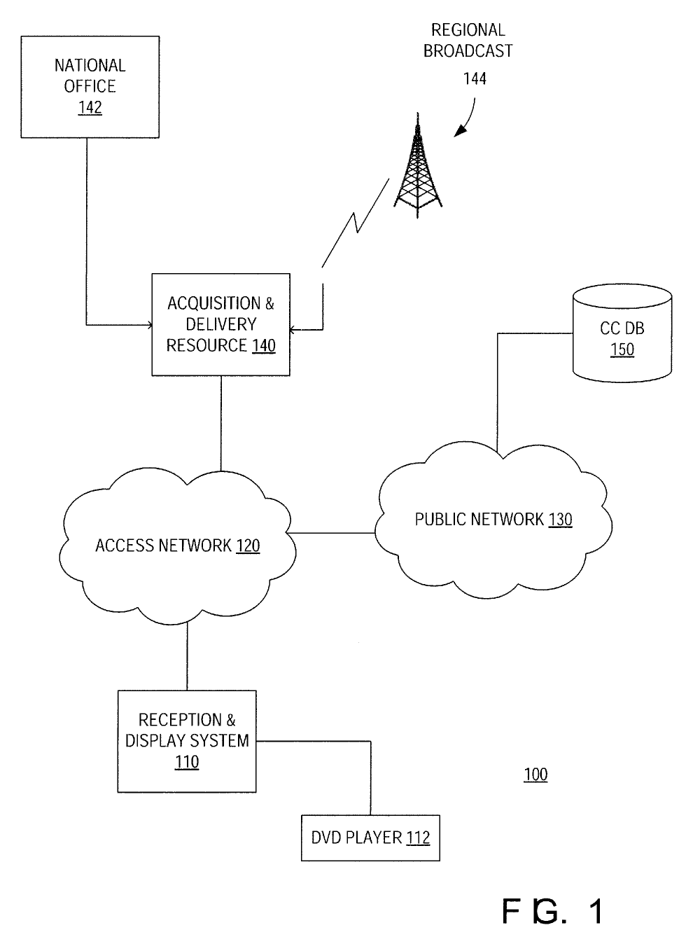

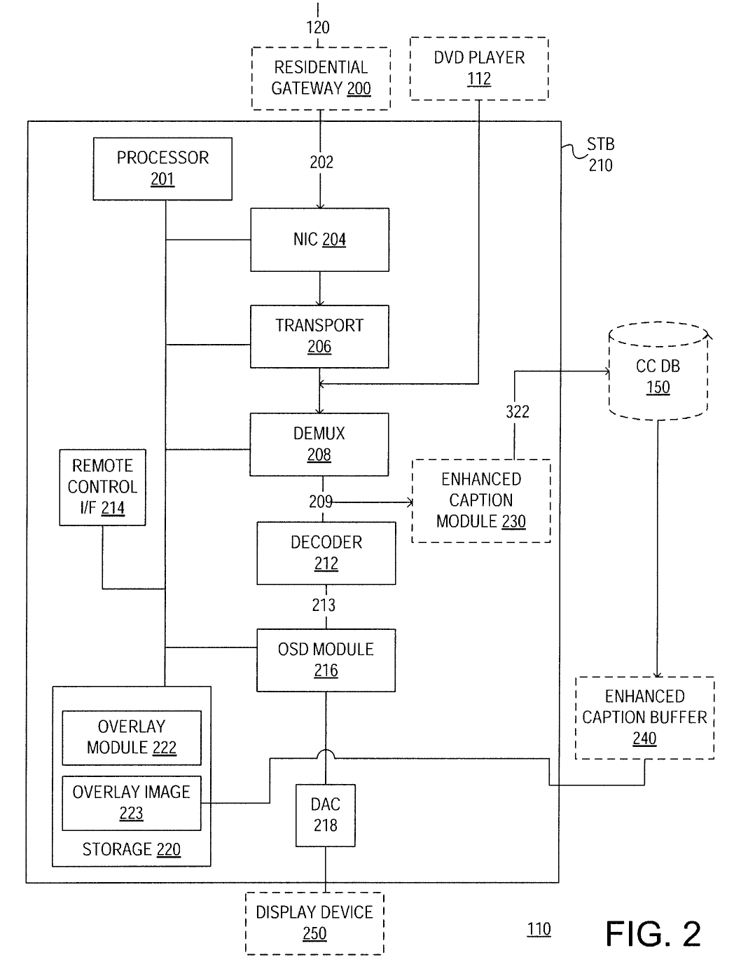

Turning now to the drawings, FIG. 1 is a block diagram illustrating selected elements of an embodiment of a multimedia content distribution network 100, sometimes referred to herein simply as network 100. In the depicted embodiment, network 100 includes a multimedia content reception and display system (RDS) 110 that may receive multimedia content streams from at least two sources. A first source of multimedia content is an access network 120 to which RDS 110 is connected and a second source of multimedia content is a DVD player 112 which is locally connected to RDS 110. RDS 110, as described in more detail below with respect to FIG. 2, may include a set top box operably connected to a television or other suitable form of display device.

As depicted in FIG. 1, an enhanced captioning database 150 is connected to a public network 130. The public network 130, in turn, is connected to access network 120. In this configuration, RDS 110 is operably connected to the enhanced captioning database 150 and enhanced captioning database 150 may be provided by a third party provider that does not necessarily have access to access network 120. Access network 120 encompasses the physical medium that connects to a user's or subscriber's residence. This physical medium may include twisted pair copper cables, coaxial cables, fiber optic cables, and other suitable media. In some embodiments, access network 120 and public network 130 are Internet Protocol (IP) based networks. Public network 130, for example, may include the Internet or portions thereof.

Access network 120 may be a private network owned, operated, and/or managed by a provider of multimedia content also referred to as the service provider. In the depicted embodiment, access network 120 connects RDS 110 to the service provider's multimedia acquisition and delivery resource 140. Acquisition and delivery resource 140 may encompass numerous servers and other devices employed in the acquisition and delivery of multimedia content. In some embodiments, acquisition and delivery resource 140 as shown may represent one of a multitude of regional offices of the service provider. In these embodiments, acquisition and delivery resource 140 may receive certain types of multimedia content, including for example, feeds of national programming, e.g., CNN and ESPN, from a national office 142, sometimes referred to as a national office or national headend. Acquisition and delivery resource 140 may also receive multimedia content from regional broadcasters represented by reference numeral 144.

Acquisition and delivery resource 140 formats or otherwise readies multimedia content for distribution to users or subscribers, one of which is represented by RDS 110. In some implementations, acquisition and delivery resource 140 simultaneously provides a plurality of multimedia content streams to many subscribers. In these embodiments, each RDS 110 is responsible for filtering the incoming signal to select the desired multimedia content stream. In some coaxial implementations, for example, the multimedia provider may deliver all or substantially all channels of content to the subscribers simultaneously and the subscriber's RDS 110 is responsible for selecting the content desired by an individual subscriber. In other embodiments, acquisition and delivery resource 140 delivers one or a small number of multimedia content streams to an individual RDS 110. In these embodiments, the RDS 110 may indicate the desired content by transmitting information indicative of a channel selected by the RDS 110. The transmitted information may cause the acquisition and delivery system 140 to transmit the requested content to the requesting RDS 110 using, for example, IP addresses associated with each RDS 110. Networks of this type may conserve bandwidth by multicasting multimedia streams to multiple subscribers or users whenever possible and unicasting streams to individuals as needed. For example, broadcast and other “live” television content may be multicasted to all subscribers who have requested the content, such as by entering the appropriate channel number on their set top boxes. Movies-on-demand, on the other hand, represent time shifted content that may be provided as requested on a fee basis and is unicasted to individual subscribers as needed.

Although the embodiment depicted in FIG. 1 illustrates enhanced captioning database 150 as being connected to public network 130, enhanced captioning database 150 may be located elsewhere. For example, enhanced captioning database 150 may be a provided and/or supported by the service provider and enhanced captioning database 150 may be connected to access network 120 or another portion of the service provider's network.

RDS 110 as shown in FIG. 1 receives multimedia content from a provider source, i.e., acquisition and delivery resource 140, via access network 120 and from a locally connected DVD player 112. Although the depicted embodiment illustrates a DVD player, other embodiments may employ other locally connected players of other types of recorded multimedia including, for example, magnetic tapes played with a video cassette player or the like.

The multimedia content provided via access network 120 may have similarities and differences with the multimedia content provided via DVD player 112. For example, in IP based embodiments of access network 120, multimedia content may be provided to RDS 110 as a series or set of discrete datagrams or packets that must be assembled or otherwise processed to obtain a multimedia stream whereas the multimedia content from DVD player 112 is generally not packet based. In both cases, however, the multimedia content may be compressed or otherwise encoded according to an encoding algorithm. Compressing and otherwise encoding multimedia content beneficially reduces that amount of data that must either be stored on a DVD within DVD player 112 or transferred across the access network 120. In some embodiments, the enhanced captioning functionality is applicable to multimedia content whether the content is provider content from acquisition and delivery resource 140 or local multimedia content from a DVD or other suitable playing device.

Turning now to FIG. 2, selected elements of an embodiment of the RDS 110 depicted in FIG. 1 are illustrated. In the illustrated implementation, RDS 110 includes a residential gateway (RG) 200, a set top box (STB) 210, an enhanced captioning module 230, an enhanced captioning buffer 240, and a display device 250. RG 200 is an optional element of RDS 110. In some embodiments, RG 200 includes a wide area network interface connected to access network 120 and a local area network (LAN) interface that connects to or supports a LAN 202 within the subscriber's premises. In some embodiments, access network 120, LAN 202, or both are IP-based networks. In other embodiments, RG 200 may support an access network 120 implemented according to a proprietary network protocol and/or a protocol that is not IP based, for example, when access network 120 includes a coaxial cable based access network. In some embodiments, RG 200 may further provide firewall, routing, and/or other functionality between access network 120 and LAN 202.

RG 200 may support a wireline or wireless Ethernet or other type of LAN 202. In the case of a wireless LAN, RG 200 may function as a wireless access port that supports wireless connections to one or more other devices. In these embodiments, STB 210 may be enabled to receive multimedia content and communicate externally via an IP based network including, for example, networks that employ a User Datagram Protocol (UDP) or Transport Control Protocol (TCP) transport layer.

The depicted embodiment of STB 210 includes a processor 201 that has access to an STB storage resource 220 and to a number of elements that facilitate the reception and display of multimedia content. STB storage resource 220 may include persistent or non-volatile storage portions, e.g., disk portions, CD or DVD portions, flash memory portions, and the like as well as volatile portions including memory portions. Some elements depicted in FIG. 2 may reside within STB 210 or be located remotely. At least some of these optional elements are shown in dashed line elements in FIG. 2. Moreover, some embodiments of some elements of STB 210 may be implemented as computer program products, namely, computer executable instructions that are stored on STB storage resource 220 or another suitable medium, where the computer executable instructions, when executed, cause RDS 110 to receive and/or display multimedia content in a manner that supports the use of enhanced captioning data.

STB 210 as depicted in FIG. 2 includes a network adapter, also referred to as a Network Interface Card (NIC) 204 that is operably connected to RG 200. NIC 204 may be implemented to support various IP or other types of network protocols including UDP/IP protocols and TCP/IP protocols. In IP based embodiments, multimedia content received by STB 210 is received as a set or sequence of IP-based datagrams or packets where each packet represents a relatively small portion of the multimedia content stream and STB 210 includes the ability to assemble the packets into a single multimedia stream. In some other embodiments, including coaxial cable based embodiments, the multimedia content received from access network 120 may include composite content that includes content from multiple individual content streams. In these embodiments, STB 210 is operable to tune or filter the composite content to select a single multimedia content for delivery. The tuning or filtering functionality of STB 210 in these embodiments may be included within the NIC 204.

The embodiment of STB 210 depicted in FIG. 2 includes a number of elements that are suitable for use with IP based implementations. In IP based implementations, which may include elements of Internet Protocol television (IPTV) networks, STB 210 as shown includes a transport module 206 and a demultiplexer (demux) 208. Transport module 206 is operable to receive a set of IP-based packets of data and to assemble the individual packets into a multimedia content stream. The multimedia content stream as assembled by transport module 206 may include a single data stream that includes information pertaining to the video stream as well as the audio stream. The demux 208 is operable to parse video components, audio components, and any control or other data components that are embedded in the multimedia transport stream. Demux 208 produces outputs that may include a video stream output, an audio stream output, and a data stream output. For purposes of clarity, only the video content stream, represented by reference numeral 209, is illustrated explicitly in FIG. 2 as an output of demux 208.

Multimedia content received from access network 120 may be compressed, encrypted, and/or otherwise encoded for a variety of reasons. Multimedia content generally requires large amounts of data to represent even a modest amount of multimedia content. When multimedia content must be delivered to one or more subscribers via a network, the limited bandwidth of the access network is generally conserved to the extent possible. Similarly, when a multimedia content title, e.g., a movie or television show, is stored on a fixed storage medium including optical disks such as DVDs, the amount of uncompressed data needed to represent the entire title may exceed the capacity of the disk. Even if the disk has sufficient capacity to contain a multimedia title, “burning” the title onto the disk will require longer using uncompressed data as opposed to compressed data. Thus, in at least some embodiments, the video content stream 209 may be a compressed and/or otherwise encoded representation of the content.

The video data that is contained in video content stream 209 is generally susceptible to significant compression because video data often includes spatial and temporal redundancies. Spatial redundancy refers to redundancy that occurs within a single frame or picture of a video content stream, e.g., spatial redundancy is present in a video frame that includes a clear blue sky as a significant part of the frame. Temporal redundancy refers to redundancy that occurs between different frames in a chronological sequence, e.g., temporal redundancy is present during a video sequence in which a foreground object moves against a relatively static background.

Various video encoding techniques or algorithms take advantage of spatial and temporal redundancies by compressing the amount of data needed to represent the video content in a way that reduces the amount of data needed to represent the redundant data, preferably without substantially reducing the amount of data representing non-redundant data. Among the video encoding standards that STB 210 may support are any of a variety of pervasive video encoding standards such as the MPEG family of encoding standards including MPEG-1, MPEG-2, and MPEG-4 as well as the WMV family of encoding standards developed by Microsoft.

In at least some of the video encoding standards supported by STB 210, the encoded video content stream 209 is represented as a series of video elements or sub elements. For example, in some embodiments, encoded video content stream 209 includes a set of encoded video frame elements where each element corresponds to a frame of multimedia content or a field of content in the case of interlaced video. For purposes of this disclosure, the term “frame” encompasses a single “picture” from the multimedia content stream whether the frame consists of two interlaced fields or not.

In at least some of the video encoding standards supported by STB 210, temporal redundancy is captured through the use of different types of encoded frames. Some frames, referred to as I-Frames, are “standalone” frames that do not include temporal references to other frames in the content stream. Other frames, however, are referenced to I-Frames or other frames in the content stream. MPEG, for example, recognizes at least two types of frames other than I-Frames, namely, P-Frames referring to frames that may be temporally predicted from a previous frame and B-Frames referring to frames that may be “bi-predicted” based on previous frames, subsequent frames, or both. In encoding schemes that employ predictive frames and non-predictive frames, the amount of temporal compression achieved is roughly indicated by the percentage of non-predictive frames. Accordingly, the number of non-predictive frames in multimedia content encoded using many open and proprietary encoding protocols is relatively small. Some embodiments of the enhanced captioning methods disclosed herein take advantage of the different types of encoded frames. In some embodiments, for example, enhanced captioning is triggered, at least in part, by the detection of an I-Frame or other temporally non-predictive frame in a video stream.

As depicted in FIG. 2, for example, RDS 110 as shown includes an enhanced captioning module 230 that is configured and operable to monitor video content stream 209. As described in greater detail below, some embodiments of enhanced captioning module 230 may be triggered to access enhanced captioning database 150 when a specified event occurs. In some embodiments, the specified event or events include the detection of an I-Frame in video content stream 209. In some of these embodiments, the first detection of an I-Frame may cause enhanced captioning module 230 to access enhanced captioning database 150 and retrieve all enhanced captioning data records corresponding to the multimedia content that is playing. Enhanced captioning module 230 may be integrated within STB 210 or provided as an external box connected to STB 210.

Returning to FIG. 2, the encoded video content stream 209 is received by a decoder 212. Decoder 212 may include or support various decoding algorithms including, for example, MPEG and WMV decoding algorithms. The video output 213 of decoder 212 is a native or uncompressed and unencrypted representation of the multimedia content stream. Video output 213 is in a format suitable for providing to a video encoder/digital-to-analog converter (DAC) 218, which formats the video output 213 for presentation on an NTSC compliant or other suitable type of display device 250. In STB 210 as depicted in FIG. 2, however, the native format video output 213 is processed by an on screen display (OSD) module 216 prior to being received by DAC 218. In some embodiments, OSD module 216 incorporates or supports an overlay module 222, depicted in FIG. 2 as residing in STB storage 220, that applies an overlay image 223 to the video image represented by video output 213. In the embodiment depicted in FIG. 2, overlay image 223 may include enhanced captioning data stored in an enhanced captioning buffer 240. In this embodiment, enhanced captioning module 230 may be triggered by an I-Frame to access a database 150 of enhanced captioning data. The enhanced captioning data from enhanced captioning database 150 is then stored in enhanced captioning buffer 240 and accessed by STB 210 through OSD module 216 and/or overlay module 223 so that enhanced captioning data in enhanced captioning database 150 is included in the video image that is displayed by display device 250.

STB 210 as shown includes a remote control interface 214. Remote control interface 214 is operable to receive and interpret a radio frequency or infrared signal from a hand held, battery powered, remote control device (not depicted). In this embodiment, the remote control interface 214 may detect and respond to an enhanced captioning signal from the remote control by enabling the enhanced captioning features described herein.

STB 210 is shown in FIG. 2 as being connected to a local source of multimedia content in the form of a DVD player 112 although other local devices operable to provide multimedia content may by substituted for DVD player 112. DVD player 112 may generate a multimedia stream that is encoded according to an encoding scheme used to encode provider supplied multimedia content received by STB 210 via NIC 204. In these embodiments, the enhanced captioning functionality disclosed herein may be invoked in conjunction with multimedia content from DVD player 112. In the depicted embodiment, content from DVD player 112 is provided to STB 210 at the input of demux 208 because DVD content generally will not require the assembly encompassed within transport module 206. In some embodiments, multimedia content from DVD player 112 may be audio/visual demultiplexed as it is stored on the DVD media. In these embodiments, multimedia content from DVD player 112 may be connected directly to the output of demux 208.

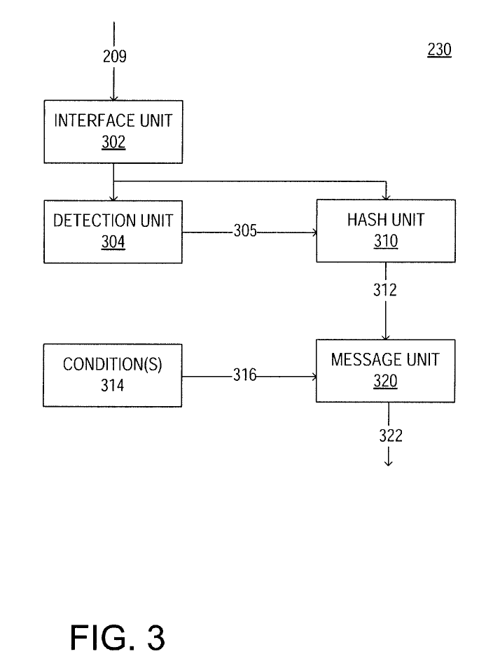

Referring to FIG. 3, as well as to FIG. 2, selected elements of an embodiment of enhanced captioning module 230 are depicted. In the depicted embodiment, enhanced captioning module 230 includes an interface unit 302, a detection unit 304, a hash unit 310 and a message unit 320. Interface unit 302 is connected to the output of demux 209, where enhanced captioning module 230 is operable to monitor encoded video frames of the multimedia content being played to display device 250. The detection unit 304 is operable to identify or otherwise determine a type associated with at least some of the frames within encoded video content stream 209. In an embodiment particularly suitable for use with MPEG and WMV encodings, for example, detection unit 304 may be operable to identify the presence of an I-Frame in the encoded video content stream 209. In these embodiments, detection unit 304 is operable to generate a trigger signal 305 when a particular type or types of video frames are detected. For example, detection unit 304 may assert trigger signal 305 when detection unit 304 monitors or otherwise identifies an I-Frame.

The hash unit 310 as shown in FIG. 3 is configured to receive copies of frames received by interface unit 302 and to receive the trigger signal 305 generated by detection unit 304. In some embodiments, hash unit 310 is operable to generate a highly, if not absolutely, unique value that corresponds to a video frame received by interface unit 302. In some embodiments, for example, hash unit 310 employs an MD5 hashing algorithm to generate a 128-bit value that corresponds to a frame that caused detection unit 304 to assert trigger 305. If, for example, detection unit 304 is configured to assert trigger signal 305 when an I-Frame is detected, hash unit 310 may be operable to execute an MD5 or other suitable hashing algorithm on the binary contents of the frame that produced the trigger signal. In these embodiments, an I-Frame from a multimedia content stream will be associated with a unique value in the form of a hashing value 312 that is then provided to message unit 320.

Message unit 320 is operable to generate a request, database query, or other type of message 322 that is deliverable to enhanced captioning database 150. In IP based embodiments, for example, message 322 may include a destination IP address corresponding to an IP address of enhanced captioning database 150. In some embodiments, the message 322 generated by message unit 320 contains the hash value 312 or other unique identifier of the corresponding multimedia content frame.

In the depicted embodiment, message unit 320 generates message 322 upon receiving hash value 312 if a condition signal 316 indicates that one or more additional conditions 314 are satisfied. The conditions 314 are imposed in some embodiments to prevent unnecessary accessing of enhanced captioning database 150. In some embodiments, for example, it may not be necessary to access enhanced captioning database 150 every time an I-Frame or other type of triggering multimedia content element is detected. If a subscriber or other user remains on a single channel, i.e., single multimedia content title, for an extended period, the initial retrieval of all records in enhanced captioning database 150 corresponding to the multimedia content title may be sufficient to support enhanced captioning for an extended period and thereby render it unnecessary for enhanced captioning module 230 to access enhanced captioning database 150 frequently. Accordingly, the conditions 314 may include a condition regarding the occurrence of a specified event, such as a change in channel, which would necessitate retrieving new enhanced captioning data. Conditions 314 may include a condition regarding a maximum refresh period, which might be enforced by imposing a refresh timer (not depicted) and accessing the enhanced captioning database 150 only when the refresh time has expired. The refresh interval might, in some embodiments, set to a value or interval that prevents extended latency when the enhanced captioning data is out of sync or otherwise incorrect without accessing the enhanced captioning database too frequently. A suitable value for the refresh interval might, in some embodiments, be an interval in the range of approximately 1 second to 15 seconds.

As shown in FIG. 2, the message 322 is sent or otherwise transmitted to enhanced captioning database 150. The message 322 contains the hash value or other information uniquely indicative of the corresponding multimedia content frame. In some embodiments, the hash value or other uniquely identifying data is used to index or otherwise query enhanced captioning database 150. If the query of enhanced captioning database 150 produces a match, the enhanced captioning database 150 may then respond by transmitting or otherwise sending one or more database records from enhanced captioning database 150 to an enhanced captioning buffer 240. In this embodiment, the enhanced captioning database 150 uses the hash value or other information from enhanced captioning module 230 as a fingerprint of the corresponding multimedia content stream. If the enhanced captioning database contains a record having the same fingerprint, the enhanced captioning database may then retrieve that matching record and, in some embodiments, all database records corresponding to the same multimedia content title. All of the records of enhanced captioning database 150 that are retrieved when enhanced captioning database 150 is queried or indexed are delivered to enhanced captioning buffer 240.

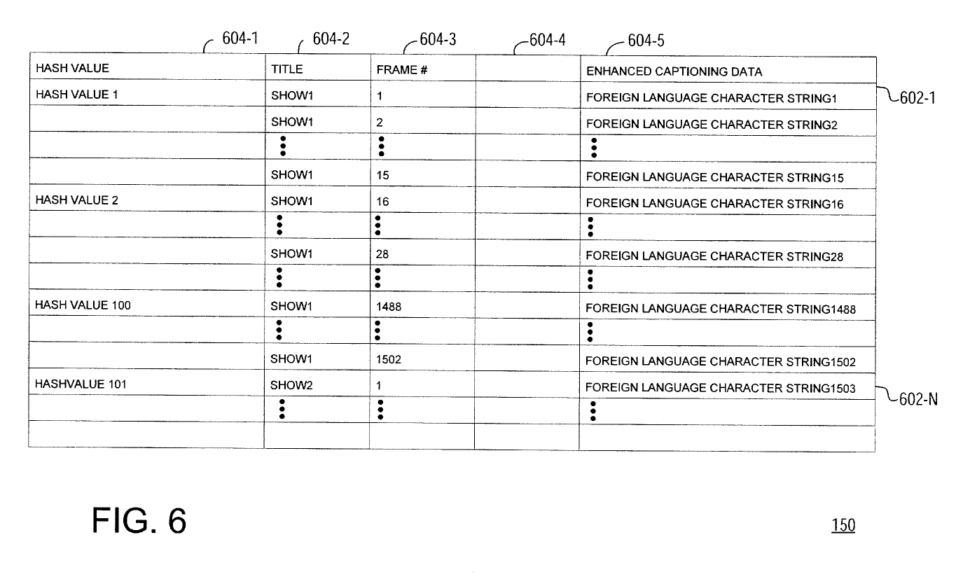

In some embodiments, the records of enhanced captioning database 150 include a field containing foreign language text data that may be used to provide enhanced captioning in a foreign language. Referring momentarily to FIG. 6, an exemplary structure of enhanced captioning database 150 according to one embodiment is depicted. In the depicted embodiment, enhanced captioning database 150 include a set of records 602-1 through 602-n where at least some of the records 602 include an enhanced captioning data field 604-5 that may include, for example, a foreign language character string. In addition to the enhanced captioning data field 604-5, the records 602 of enhanced captioning database 150 as shown include a title field 604-2, a frame number field 604-3, and a hash value field 604-1. As illustrated in FIG. 6, not all of the records 602 of enhanced captioning database 150 include a value stored in hash value field 604-1. In some embodiments, for example, enhanced captioning database 150 includes a record 602 for all or substantially all frames in the multimedia content stream, but only those records that represent triggering records contain a value in hash value field 604-1. In this embodiment, for example, all frames, whether I-Frame or otherwise have a corresponding record 602 in enhanced captioning database 150, but only I-Frames have a value in hash value field 604-1. In this implementation, the database records corresponding to I-Frames may be referred to as “key” records to indicate, in this implementation, that the type of frame is a key indicator off of which the enhanced captioning module 230 bases at least some of its behavior. Moreover, the hash value field 604-1 may be referred to as the identity information field to encompass embodiments that use a value other than a hash value for field 604-1. Similarly, the frame number field 604-3 may be referred to as sequence field 604-3.

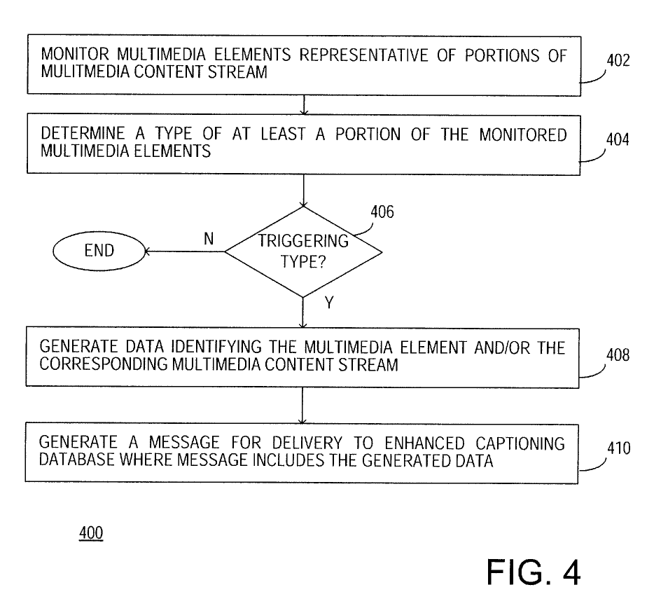

As indicated previously, at least some embodiments described herein are implemented as computer program products, which refers to computer executable instructions that are stored in a tangible computer readable medium such as a hard disk, optical disk, flash memory, volatile system memory, or the like. Referring to FIG. 4, a flow diagram illustrates a method 400 corresponding to a computer program product for supporting the provisioning of enhanced captioning data. In the depicted embodiment, method 400 includes enhanced captioning module 230 or another suitable resource monitoring (block 402) encoded frames or other types of elements or sub elements of a multimedia content stream where the monitored elements represent or are otherwise indicative of portions of a multimedia content stream.

Method 400 as shown includes determining (block 404) a type for a monitored frame, element, or sub element. If a monitored frame has a type that causes triggering, as determined in block 406, the triggering signal 305 depicted FIG. 3 is asserted. When the triggering type signal is asserted in block 406, the method 400 includes generating (block 408) data identifying the multimedia element and/or the corresponding multimedia content stream. As described above, for example, block 408 may include generating a hashing value from the binary contents of a frame in the video content stream. Method 400 as depicted further includes then generating (block 410) a message for delivery to an enhanced captioning database where the message includes the hash value or other generated data. The message when received by enhanced captioning database 150 will be used to index or otherwise query the database to identify all or at least some of the records that include the enhanced captioning text data.

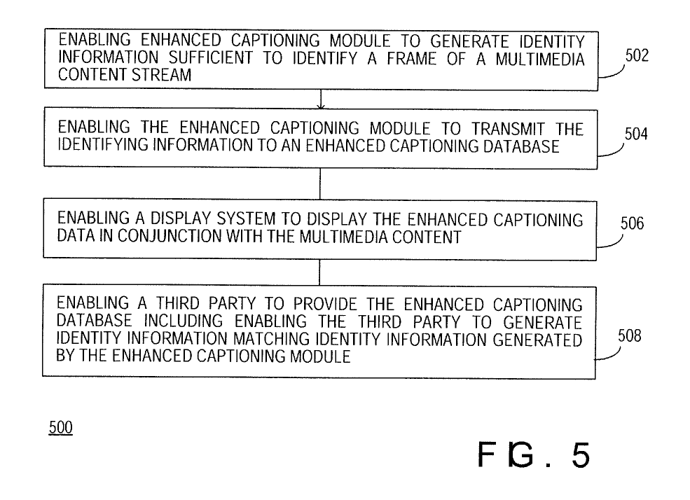

In some embodiments, the disclosed methods are implemented as a method of enabling others to provide or use enhanced captioning. Referring, for example, to FIG. 5, an embodiment of a method 500 for enabling enhanced captioning features as described herein is illustrated. In the depicted embodiment, method 500 includes enabling (block 502) an enhanced captioning module to generate identity information that is sufficient to uniquely identify a frame of a multimedia content stream. Method 500 as shown further includes enabling (block 504) the enhanced captioning module to transmit the identifying information to an enhanced captioning database 150. A display system such as RDS 110 is enabled (block 506) to display the enhanced captioning data in conjunction with the multimedia content as the multimedia content is played.

Method 500 as depicted in FIG. 5 includes an optional element of enabling (block 508) a third party provider to provide enhanced captioning database 150. Enabling a third party provider to provide enhanced captioning database 150 may include publishing or otherwise making information available to the third party provider that enables the third party provider to format and implement its enhanced captioning database in a manner that is compatible to the manner in which enhanced captioning module 230 accesses the database. For example, the multimedia service provider may establish a set of application program interfaces (APIs) that a third party provider may include in its code to ensure that the format of the database and the manner of accessing it are compatible with the implementation of enhanced captioning module 230.

Enabling third party providers to implement enhanced captioning database 150 beneficially achieves multiple desirable goals. Development of enhanced captioning text is delegated to entities presumably most familiar with the applicable languages and most familiar with the multimedia content that is in high demand among speakers of a particular language. Enabling a third party enhanced captioning database 150 also frees the service provider from having to develop its own multimedia content for each piece of multimedia title. In addition, enabling third party provision of enhanced captioning database 150 encourages competition among providers of enhanced captioning services that might ensure competitive pricing and adequate quality control. Although block 508 is depicted as an element of method 500, the third party enablement functionality represented by block 508 may be implemented as a separate and distinct method.

Although the disclosed subject matter has been disclosed in the context of foreign language closed captioning information, the described elements and methods are suitable for being implemented in other contexts. For example, another embodiment may employ enhanced captioning database 150 to present explanatory or otherwise educational information during presentation of a multimedia film. This type of text could be used to supplement or replace narrative that is included in a multimedia content title. A third party provider might, in this embodiment, employ enhanced captioning database 150 and enhanced captioning module 230 to supplement content.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An enhanced captioning module suitable for use in a multimedia reception and display system, comprising:
an interface to receive a set of multimedia elements representative of at least a portion of multimedia content;
a detection unit to determine a type of at least a portion of the multimedia elements and to assert a trigger signal when a type of a triggering multimedia element matches a selected type;
a hash unit to generate a hash value corresponding to the triggering multimedia element; and
a message unit to generate a message deliverable to an enhanced captioning database and indicative of the hash value wherein the enhanced captioning database includes enhanced captioning data corresponding to the multimedia content.

2. The module of claim 1, wherein the multimedia content includes a sequence of frames and wherein the multimedia elements comprise encoded representations of the frames.

3. The module of claim 2, wherein types of the multimedia elements include an I-type and at least one other type, wherein an I-type multimedia element is encoded without reference to preceding or subsequent multimedia elements.

4. The module of claim 3, wherein a triggering multimedia element includes a multimedia element having an I-type.

5. The module of claim 4, wherein an I-type element is encoded in compliance with an encoding standard selected from the group of encoding standards consisting of MPEG-1, MPEG-2, and MPEG-4.

6. The module of claim 4, wherein the message unit generates the message responsive to satisfaction of a condition, wherein the condition includes the trigger signal being asserted.

7. The module of claim 6, wherein the condition further includes an additional condition, wherein the additional condition is selected from the set of conditions consisting of a refresh interval expiring and a channel change occurring.

8. The module of claim 1, wherein the message unit is operable to transmit the message to the enhanced captioning database via a network to which the enhanced captioning database is connected, wherein the network to which the enhanced captioning database is connected includes a network selected from a public network and a private access network.

9. The module of claim 8, wherein the message is operable to query the enhanced captioning database using the hash value.

10. The module of claim 9, wherein the message is operable to cause the enhanced captioning database to transmit at least a portion of the enhanced captioning data to an enhanced captioning buffer.

11. The module of claim 10, wherein the enhanced captioning buffer is accessible to a set top box operable to cause a display device to display the enhanced captioning data in conjunction with displaying the multimedia content.

12. The module of claim 11, wherein the enhanced captioning data comprises enhanced captioning text in a language other than English, French, and Spanish.

13. The module of claim 11, wherein the enhanced captioning module comprises an element of the set top box.

14. A method of implementing enhanced captioning for multimedia content, comprising:
enabling an enhanced captioning module to generate identity information sufficient to identify a frame of a multimedia content stream;
enabling the enhanced captioning module to transmit the identifying information to an enhanced captioning database, wherein the identifying information causes the enhanced captioning database to transmit enhanced captioning data applicable to the identified frame to an enhanced captioning buffer; and
enabling a display system including a set top box operable access to the enhanced captioning buffer to display the enhanced captioning data in conjunction with the multimedia content.

15. The method of claim 14, wherein enabling the enhanced captioning module to generate the identity information comprises enabling the enhanced captioning module to generate a hash value corresponding to data representing the frame.

16. The method of claim 14, wherein enabling the enhanced captioning module to transmit the identifying information comprises enabling the enhanced captioning module to transmit the identifying information when at least one condition is satisfied.

17. The method of claim 16, wherein the at least one condition includes a frame type condition determined at least in part on whether a frame comprises an encoded frame encoded in compliance with an MPEG video encoding standard.

18. The method of claim 17, wherein the frame type condition is determined at least in part on whether the frame comprises an I-Frame wherein an I-Frame does not reference a previous or subsequent frame in the multimedia content stream.

19. The method of claim 17, wherein the at least one condition further includes a secondary condition determined at least in part by whether a refresh interval has expired.

20. The method of claim 19, wherein the refresh interval expires periodically or from time to time.

21. The method of claim 17, wherein the at least one condition further includes a second condition determined at least in part by whether a channel change has occurred.

22. The method of claim 14, wherein the enhanced captioning data comprises enhanced captioning text wherein a language of the enhanced captioning text is a language other than English, French, or Spanish.

23. The method of claim 14, further comprising enabling a third party to provide the enhanced captioning database including enabling the third party to generate identity information matching the identity information generated by the enhanced captioning module.

24. The method of claim 14, wherein the enhanced captioning database includes a plurality of key records wherein at least some of the key records include an identity information field and a corresponding enhanced captioning data field.

25. The method of claim 24, wherein the enhanced captioning database further includes intermediate records including a sequence field and a corresponding enhanced captioning data field.

26. A computer program product, comprising computer executable instructions, stored on a computer readable medium, for processing enhanced captioning data pertaining to multimedia content, the instructions comprising instructions to:
monitor a set of multimedia elements representative of at least a portion of multimedia content being played to a display device;
determine a type of at least a portion of the multimedia elements and to identify a multimedia element as a triggering multimedia element when a type of the multimedia element matches a selected type;
generate a hash value corresponding to the triggering multimedia element; and
generate a message deliverable to an enhanced captioning database and indicative of the hash value wherein the enhanced captioning database includes enhanced captioning data corresponding to the multimedia content.

27. The computer program product of claim 26, wherein the multimedia elements include encoded representations of multimedia frames and where the instructions to identify a multimedia element as a triggering element comprises instructions to identify frames having an I-type as triggering elements, wherein an I-type frame lacks temporal references to any other frames.

28. The computer program product of claim 27, where the multimedia elements are encoded in compliance with a video encoding specification selected from the set of video encoding specifications consisting of MPEG-1, MPEG-2, MPEG-4, and Windows Media Video (WMV).
